(19) United States
(12) Patent Application Publication
(10) Pub. No.: US 2023/0057032 A1
(43) Pub. Date: Feb. 23, 2023

(54) GAS SENSOR

(71) Applicant: NGK INSULATORS, LTD., Nagoya-shi (JP)

(72) Inventors: Yusuke WATANABE, Nagoya-shi (JP); Shota KAGEYAMA, Nagoya-shi (JP); Yuki NAKAYAMA, Nagoya-shi (JP)

(21) Appl. No.: 17/981,528

(22) Filed: Nov. 7, 2022

Related U.S. Application Data
(62) Division of application No. 16/718,238, filed on Dec. 18, 2019.

(30) Foreign Application Priority Data
Dec. 25, 2018 (JP) 2018-240774

(51) Int. Cl. G01N 27/419; G01N 27/407

(52) U.S. Cl. CPC G01N 27/419; G01N 27/4072; G01N 27/4073

(57) ABSTRACT

A sensor element and fabrication method thereof, the sensor element includes: a main pump cell including an inner pump electrode facing a first inner space into which a measurement gas is introduced, an external pump electrode provided on an element surface, and a solid electrolyte therebetween; an auxiliary pump cell including an auxiliary pump electrode provided facing a second inner space, the external pump electrode, and the solid electrolyte therebetween; and a measurement pump cell including a measurement electrode, the external pump electrode, and the solid electrolyte therebetween. The inner pump electrode has a porosity of 10 - 25%, the auxiliary pump electrode has a porosity of 30 - 50%, a thickness ratio of both the electrodes is 1.0 - 4.0, and current flowing to the main pump cell has a current density of 0.05 - 0.5 mA/mm² when the measurement gas has an oxygen concentration of 20.5%.

### CROSS-REFERENCE TO RELATED APPLICATION

The present application claims priority from Japanese application JP2018-240774, filed on Dec. 25, 2018, the contents of which is hereby incorporated by reference into this application.

### BACKGROUND OF THE INVENTION

### Field of the Invention

The present invention relates to a gas sensor configured to determine the concentration of nitrogen oxide (NOx), and particularly to performance improvement.

### Description of the Background Art

Already known is a limiting current type gas sensor (NOx sensor) using a sensor element which mainly has an oxygen ion conductive solid electrolyte as a constituent (for example, see Japanese Patent Application Laid-Open No. 2009-244117). In order to obtain the NOx concentration in such a gas sensor, a measurement gas is firstly introduced into a space provided inside the sensor element (an inner space) under a diffusion resistance, and oxygen in the measurement gas is pumped out in an electrochemical pump cell provided in two stages such as a main pump cell and an auxiliary pump cell to sufficiently lower the oxygen concentration in the measurement gas previously. Thereafter, NOx in the measurement gas is reduced or decomposed at a measurement electrode functioning as a reduction catalyst, and oxygen thus generated is pumped out by an electrochemical pump cell including the measurement electrode and referred to as, for example, a measurement pump cell. The concentration of NOx is obtained by using a fact that current flowing in the measurement pump cell (NOx current) has a certain functional relationship with the concentration of NOx.

Japanese Patent Application Laid-Open No. 2009-244117 discloses a configuration in which the porosity of a main pump cell electrode (inner pump electrode) and an auxiliary pump cell electrode (auxiliary pump electrode) provided inside the element is set to be in a predetermined range to reduce offset current flowing through the measurement pump cell when no NOx is present in the measurement gas (current generated through decomposition of O₂ slightly present in a measurement gas), and the oxygen concentration gradient in each electrode is reduced, thereby to improve the measurement accuracy of a NOx sensor.

However, even when the configuration disclosed in Japanese Patent Application Laid-Open No. 2009-244117 is adopted to a gas sensor, it has been confirmed by the inventor of the present invention through earnest examination that there is room for improvement in the following points, depending on circumstances.

First, it was confirmed that, when the inner pump electrode has a high porosity and a small thickness and thus the current density of current flowing through the main pump cell is large, there is room for improvement in the peelability of the inner pump electrode from a base made of a solid electrolyte and the durability of the inner pump electrode.

When the auxiliary pump electrode has a low porosity and a large thickness, the oxygen concentration gradient occurs inside the auxiliary pump electrode and the offset current is potentially large, depending on the use situation.

Furthermore, it was confirmed that, when the porosity difference between the inner pump electrode and the auxiliary pump electrode is large, there is room for improvement in the controllability of feedback control at each pump cell, depending on the use situation.

### SUMMARY

The present invention is directed to a gas sensor configured to determine the concentration of nitrogen oxide (NOx), and particularly relates to performance improvement.

According to the present invention, in a limiting current type gas sensor including a sensor element made of an oxygen-ion conductive solid electrolyte and capable of specifying the concentration of NOx in a measurement gas, the sensor element includes: a gas inlet through which the measurement gas is introduced from an external space; a first inner space communicated with the gas inlet under a predetermined diffusion resistance; a second inner space communicated with the first inner space under a predetermined diffusion resistance; a main pump cell as an electrochemical pump cell including an inner pump electrode provided facing the first inner space, an external pump electrode provided on a surface of the sensor element, and the solid electrolyte provided between the inner pump electrode and the external pump electrode; an auxiliary pump cell as an electrochemical pump cell including an auxiliary pump electrode provided facing the second inner space, the external pump electrode, and the solid electrolyte provided between the auxiliary pump electrode and the external pump electrode; a measurement electrode disposed inside the sensor element and interposing at least a diffusion limiting part between the measurement electrode and the second inner space; and a measurement pump cell as an electrochemical pump cell including the measurement electrode, the external pump electrode, and the solid electrolyte provided between the measurement electrode and the external pump electrode. The inner pump electrode has a porosity P1 of 10% to 25%, the auxiliary pump electrode has a porosity P2 of 30% to 50%, a ratio T1/T2 of a thickness T1 of the inner pump electrode to a thickness T2 of the auxiliary pump electrode is 1.0 to 4.0, and the gas sensor is configured and disposed so that current flowing to the main pump cell has a current density of 0.05 mA/mm² to 0.5 mA/mm² when the measurement gas has an oxygen concentration of 20.5%.

According to the present invention, provision of durability of the inner pump electrode and reduction of offset current are both achieved in the gas sensor.

Preferably, in the gas sensor according to the present invention, the sensor element further includes: an air introduction layer to which air is introduced as a reference gas from outside of the sensor element; a reference electrode covered by the air introduction layer; a main pump control sensor cell as an electrochemical sensor cell including the inner pump electrode, the reference electrode, and the solid electrolyte provided between the inner pump electrode and the reference electrode; an auxiliary pump control sensor cell as an electrochemical sensor cell including the auxiliary pump electrode, the reference electrode, and the solid electrolyte provided between the auxiliary pump electrode and the reference electrode; and a measurement pump control sensor cell as an electrochemical sensor cell including the measurement electrode, the reference electrode, and the solid electrolyte provided between the measurement electrode and the reference electrode, the main pump cell is configured and disposed to pump out oxygen in the measurement gas in the first inner space by applying, between the inner pump electrode and the external pump electrode, the main pump voltage in accordance with electromotive force generated between the inner pump electrode and the reference electrode in the main pump control sensor cell, the auxiliary pump cell is configured and disposed to pump out oxygen in the measurement gas introduced into the second inner space by applying, between the auxiliary pump electrode and the external pump electrode, pump voltage in accordance with electromotive force generated between the auxiliary pump electrode and the reference electrode in the auxiliary pump control sensor cell so that the measurement gas having an oxygen partial pressure thus made to be lower than in the first inner space reaches the measurement electrode, the measurement pump cell is configured and disposed to pump out oxygen generated at the measurement electrode by applying, between the measurement electrode and the external pump electrode, pump voltage in accordance with electromotive force generated between the measurement electrode and the reference electrode in the measurement pump control sensor cell, and a porosity difference P2-P1 between the inner pump electrode and the auxiliary pump electrode is 30% or smaller.

Accordingly, improvement of feedback controllability of each pump cell is achieved.

Thus, the present invention is intended to provide a gas sensor that can reliably obtain an excellent operation characteristic as compared to conventional cases.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically showing an exemplary configuration of a gas sensor 100;

FIG. 2 is a diagram showing the relation between pump voltage Vp0 and pump current Ip0 at a main pump cell 21 of a sensor element 101 when the oxygen concentration of a measurement gas is 20.5%;

FIG. 3 is a drawing showing a flow of processing in manufacturing a sensor element 101; and

FIG. 4 is a diagram schematically showing an exemplary configuration of a gas sensor 200.

### DESCRIPTION OF THE PREFERRED EMBODIMENTS

### Schematic Configuration of Gas Sensor

Described first is a schematic configuration of a gas sensor 100 including a sensor element 101 according to the present preferred embodiment. In the present preferred embodiment, the gas sensor 100 is a limiting current type NOx sensor which detects NOx using the sensor element 101 to measure a concentration of NOx.

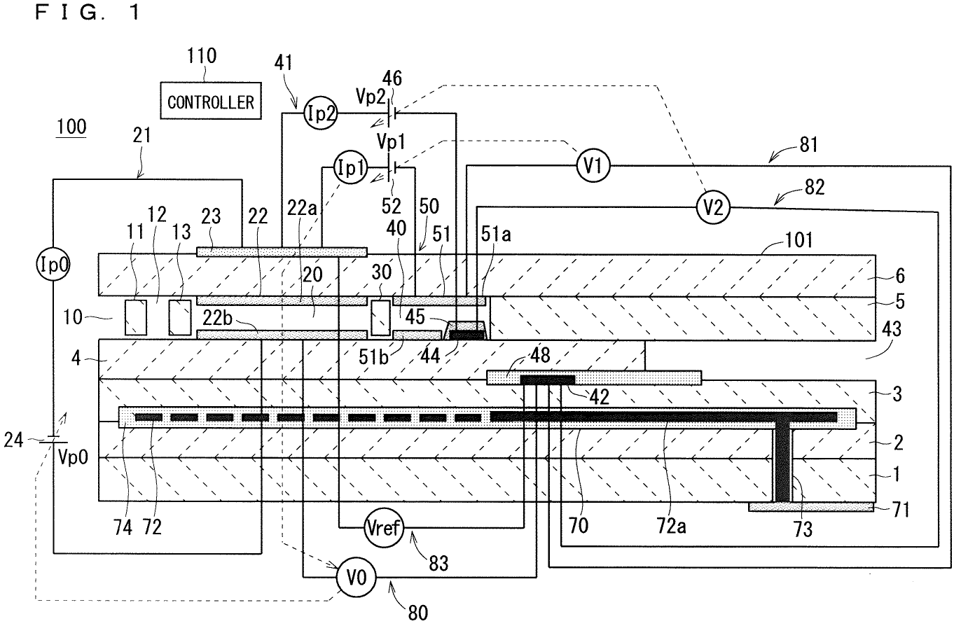

FIG. 1 is a drawing schematically showing an example of a configuration of the gas sensor 100 including a vertical sectional view of the sensor element 101 along a longitudinal direction.

The sensor element 101 is a flat plate like (elongated plate like) element having a structure made up of six solid electrolyte layers of a first substrate layer 1, a second substrate layer 2, a third substrate layer 3, a first solid electrolyte layer 4, a spacer layer 5, and a second solid electrolyte layer 6, each of which is formed of zirconia (ZrO₂) which is an oxygen ion conductive solid electrolyte (for example, yttrium stabilized zirconia (YSZ)), laminated from a lower side in this order when seeing a drawing sheet of FIG. 1. The solid electrolyte forming these six layers is dense and airtight. In the subsequent description, a surface on an upper side of each of these six layers in FIG. 1 is simply referred to as an upper surface, and a surface on a lower side thereof is simply referred to as a lower surface in some cases. A whole part made of the solid electrolyte in the sensor element 101 is collectively referred to as a base part.

The sensor element 101 is manufactured by performing a predetermined processing and printing a circuit pattern on a ceramic green sheet corresponding to each layer, then laminating the green sheets, and further firing to integrate them with each other, for example.

A gas inlet 10, a first diffusion limiting part 11, a buffer space 12, a second diffusion limiting part 13, a first inner space 20, a third diffusion limiting part 30, and a second inner space 40 are adjacently formed to be communicated with each other in this order between a lower surface of the second solid electrolyte layer 6 and an upper surface of the first solid electrolyte layer 4 in one end of the sensor element 101.

The gas inlet 10, the buffer space 12, the first inner space 20, and the second inner space 40 are spaces in the sensor element 101 that look as if they were provided by hollowing out the spacer layer 5, an upper part thereof defined by the lower surface of the second solid electrolyte layer 6, a lower part thereof defined by the upper surface of the first solid electrolyte layer 4, and a side part thereof defined by the side surface of the spacer layer 5.

Each of the first diffusion limiting part 11, the second diffusion limiting part 13, and the third diffusion limiting part 30 is provided as two horizontally long slits (with an opening having a longitudinal direction perpendicular to the drawing sheet of FIG. 1). A region from the gas inlet 10 to the second inner space 40 is also referred to as a gas distribution part.

A reference gas introduction space 43 is provided in a position farther away from an end side in relation to the gas introduction part between the upper surface of the third substrate layer 3 and the lower surface of the spacer layer 5, a side part thereof defined by a side surface of the first solid electrolyte layer 4. Atmospheric air, for example, is introduced into the reference gas introduction space 43 as a reference gas in measuring the NOx concentration.

An atmospheric air introduction layer 48 is a layer formed of porous alumina, and the reference gas is introduced into the atmospheric air introduction layer 48 through the reference gas introduction space 43. The atmospheric air introduction layer 48 is formed to cover a reference electrode 42.

The reference electrode 42 is an electrode having a configuration of being sandwiched between the upper surface of the third substrate layer 3 and the first solid electrolyte layer 4, and the atmospheric air introduction layer 48 leading to the reference gas introduction space 43 is provided around the reference electrode 42 as described above. An oxygen concentration (oxygen partial pressure) in the first inner space 20 and the second inner space 40 can be measured using the reference electrode 42 as described hereinafter.

The gas inlet 10 is a portion having an opening to an outer space in the gas introduction part, and the measurement gas is taken into the sensor element 101 from the outer space through the gas inlet 10.

The first diffusion limiting part 11 is a portion for providing the measurement gas taken from the gas inlet 10 of the predetermined diffusion resistance.

The buffer space 12 is a space provided for leading the measurement gas, which is introduced from the first diffusion limiting part 11, to the second diffusion limiting part 13.

The second diffusion limiting part 13 is a portion for providing the measurement gas introduced from the buffer space 12 to the first inner space 20 of the predetermined diffusion resistance.

In the introduction of the measurement gas from outside the sensor element 101 into the first inner space 20, the measurement gas rapidly taken into the sensor element 101 from the gas inlet 10 in accordance with a pressure variation of the measurement gas in the outer space (a pulsation of an exhaust gas pressure in a case where the measurement gas is an exhaust gas of a vehicle) is not directly introduced into the first inner space 20, but is introduced into the first inner space 20 after a concentration variation of the measurement gas is canceled through the first diffusion limiting part 11, the buffer space 12, and the second diffusion limiting part 13. Thus, the concentration variation of the measurement gas introduced into the first inner space 20 is substantially negligible.

The first inner space 20 is provided as a space for adjusting the oxygen partial pressure in the measurement gas introduced through the second diffusion limiting part 13. The oxygen partial pressure is adjusted by an operation of a main pump cell 21.

The main pump cell 21 is an electrochemical pump cell including: an inner pump electrode (also referred to as a main pump electrode) 22 including a ceiling electrode part 22a provided on substantially the entire lower surface of the second solid electrolyte layer 6 facing the first inner space 20; an external pump electrode 23 provided being exposed to the external space in a region corresponding to the ceiling electrode part 22a on the upper surface of the second solid electrolyte layer 6 (one main surface of the sensor element 101); and the second solid electrolyte layer 6 sandwiched between these electrodes.

The inner pump electrode 22 is formed on upper and lower solid electrolyte layers (the second solid electrolyte layer 6 and the first solid electrolyte layer 4) partitioning the first inner space 20. Specifically, the ceiling electrode part 22a is formed on the lower surface of the second solid electrolyte layer 6 providing a ceiling surface of the first inner space 20, and a bottom electrode part 22b is formed on the upper surface of the first solid electrolyte layer 4 providing a bottom surface of the first inner space 20. The ceiling electrode part 22a and the bottom electrode part 22b are connected with each other at a conduction part provided on a sidewall surface (inner surface) of the spacer layer 5 forming both sidewall parts of the first inner space 20 (not shown).

The ceiling electrode part 22a and the bottom electrode part 22b are provided in rectangular shapes in plan view. However, only the ceiling electrode part 22a or only the bottom electrode part 22b may be provided.

The ceiling electrode part 22a and the bottom electrode part 22b are each preferably provided to have a thickness of 5 µm to 30 µm and an area of 5 mm² to 20 mm². Hereinafter, the average thickness and area of the ceiling electrode part 22a and the bottom electrode part 22b are simply referred to as the thickness and area of the inner pump electrode 22, respectively.

The inner pump electrode 22 is formed as a porous cermet electrode of Pt and ZrO₂. In other words, the inner pump electrode 22 does not contain Au. This seems to be disadvantageous from the viewpoint of suppressing decomposition of NOx in the first inner space 20, but in the gas sensor 100 according to the present preferred embodiment, decomposition of NOx in the first inner space 20 is excellently suppressed by configuring the sensor element 101 so that each component of the sensor element 101 satisfies a predetermined requirement as described later in detail. The weight ratio of Pt and ZrO₂ in the inner pump electrode 22 may be Pt : ZrO₂ = 8.5 : 1.5 to 6.0 : 4.0 approximately.

In the meanwhile, the external pump electrode 23 is formed to have a rectangular shape in a plan view as a cermet electrode made of Pt or a Pt alloy and ZrO₂, for example.

In the main pump cell 21, a desired pump voltage Vp0 is applied between the inner pump electrode 22 and the external pump electrode 23 by a variable source 24, and a pump current Ip0 is flowed between the inner pump electrode 22 and the external pump electrode 23 in a positive direction or a negative direction, thus oxygen in the first inner space 20 can be pumped out to the outer space or oxygen in the outer space can be pumped into the first inner space 20. The pump voltage Vp0 applied between the inner pump electrode 22 and the external pump electrode 23 in the main pump cell 21 is also referred to as the main pump voltage Vp0.

The inner pump electrode 22, the second solid electrolyte layer 6, the spacer layer 5, the first solid electrolyte layer 4, the third substrate layer 3, and the reference electrode 42 constitute an electrochemical sensor cell, that is to say, a main-pump-control oxygen-partial-pressure detection sensor cell 80 to detect the oxygen concentration (oxygen partial pressure) in the atmosphere in the first inner space 20.

The oxygen concentration (oxygen partial pressure) in the first inner space 20 can be figured out by measuring an electromotive force V0 in the main-pump-control oxygen-partial-pressure detection sensor cell 80.

Furthermore, a feedback control is performed on the main pump voltage Vp0 so that the electromotive force V0 is set to constant, thus the pump current Ip0 is controlled. Accordingly, the oxygen concentration in the first inner space 20 is maintained to have a predetermined constant value.

The third diffusion limiting part 30 is a portion of providing the measurement gas, whose oxygen concentration (oxygen partial pressure) is controlled by an operation of the main pump cell 21 in the first inner space 20, of a predetermined diffusion resistance, and guiding the measurement gas to the second inner space 40.

The second inner space 40 is provided as a space for performing processing according to the measurement of nitrogen oxide (NOx) in the measurement gas introduced through the third diffusion limiting part 30. The NOx concentration is measured mainly in the second inner space 40 where the oxygen concentration is adjusted by an auxiliary pump cell 50, by an operation of a measurement pump cell 41.

In the second inner space 40, the adjustment of the oxygen partial pressure of the measurement gas whose oxygen concentration (oxygen partial pressure) has been previously adjusted in the first inner space 20 and subsequently introduced through the third diffusion limiting part 30 is further performed by the auxiliary pump cell 50. Accordingly, the oxygen concentration in the second inner space 40 can be accurately maintained constant, thus the gas sensor 100 enables the highly accurate NOx concentration measurement.

The auxiliary pump cell 50 is an auxiliary electrochemical pump cell constituted by an auxiliary pump electrode 51 having a ceiling electrode part 51a provided on almost the entire lower surface of the second solid electrolyte layer 6 facing the second inner space 40, the external pump electrode 23 (not limited to the external pump electrode 23 but an appropriate electrode outside the sensor element 101 is also applicable), and the second solid electrolyte layer 6.

The auxiliary pump electrode 51 is disposed in the second inner space 40 similarly to the inner pump electrode 22 provided in the first inner space 20 described above. In other words, the ceiling electrode part 51a is formed on the second solid electrolyte layer 6 providing a ceiling surface of the second inner space 40, and a bottom electrode part 51b is formed on the first solid electrolyte layer 4 providing a bottom surface of the second inner space 40. Each of the ceiling electrode part 51a and the bottom electrode part 51b has a rectangular shape in a plan view and is connected to each other in a conduction part provided on a sidewall surface (an inner surface) of the spacer layer 5 constituting both sidewall parts of the second inner space 40 (the illustration is omitted).

The ceiling electrode part 51a and the bottom electrode part 51b are each preferably provided to have a thickness of 5 µm to 30 µm and an area of 5 mm² to 20 mm². Hereinafter, the thickness and area of the ceiling electrode part 51a and the bottom electrode part 51b are simply referred to as the thickness and area of the auxiliary pump electrode 51, respectively.

The auxiliary pump electrode 51 is formed of a material having weakened reducing ability for an NOx component in the measurement gas. For example, the auxiliary pump electrode is formed as a cermet electrode of an Au-Pt alloy and ZrO₂.

In the auxiliary pump cell 50, a desired pump voltage Vp1 is applied between the auxiliary pump electrode 51 and the external pump electrode 23, thus oxygen in the atmosphere in the second inner space 40 can be pumped out to the outer space or oxygen can be pumped from the outer space into the second inner space 40.

The auxiliary pump electrode 51, the reference electrode 42, the second solid electrolyte layer 6, the spacer layer 5, the first solid electrolyte layer 4, and the third substrate layer 3 constitute an electrochemical sensor cell, that is to say, an auxiliary-pump-control oxygen-partial-pressure detection sensor cell 81 to control the oxygen partial pressure in the atmosphere in the second inner space 40.

The auxiliary pump cell 50 performs pumping with a variable source 52 whose voltage control is performed based on an electromotive force V1 detected in the auxiliary pump control oxygen-partial-pressure detection sensor cell 81. Accordingly, the oxygen partial pressure in the atmosphere in the second inner space 40 is controlled so that it is low enough not to substantially influence the measurement of NOx.

In accordance with this, a pump current Ip1 thereof is used for controlling the electromotive force of the main-pump-control oxygen-partial-pressure detection sensor cell 80. Specifically, the pump current Ip1 is input, as a control signal, into the main-pump-control oxygen-partial-pressure detection sensor cell 80, and, through control of the electromotive force V0 thereof, the oxygen partial pressure in the measurement gas introduced through the third diffusion limiting part 30 into the second inner space 40 is controlled to have a gradient that is always constant. In using the gas sensor 100 as an NOx sensor, the oxygen concentration in the second inner space 40 is maintained to have a constant value of approximately 0.001 ppm by the functions of the main pump cell 21 and the auxiliary pump cell 50.

The measurement pump cell 41 measures the NOx concentration in the measurement gas in the second inner space 40. The measurement pump cell 41 is an electrochemical pump cell constituted by a measurement electrode 44 provided on the upper surface of the first solid electrolyte layer 4 facing the second inner space 40 in a position separated from the third diffusion limiting part 30, the external pump electrode 23, the second solid electrolyte layer 6, the spacer layer 5, and the first solid electrolyte layer 4.

The measurement electrode 44 is a porous cermet electrode. For example, the measurement electrode 44 is formed as a cermet electrode made of Pt or an alloy of Pt and ZrO₂. The measurement electrode 44 also functions as an NOx reduction catalyst for reducing NOx in the atmosphere in the second inner space 40. Furthermore, the measurement electrode 44 is covered with a fourth diffusion limiting part 45.

The fourth diffusion limiting part 45 is a film formed of a porous material mainly containing alumina (Al₂O₃). The fourth diffusion limiting part 45 has a function of limiting an amount of NOx flowing into the measurement electrode 44, and also functions as a protection film of the measurement electrode 44.

The measurement pump cell 41 can pump out oxygen generated by the resolution of NOx in the atmosphere around the measurement electrode 44 and detect a generation amount of oxygen as a pump current Ip2.

The second solid electrolyte layer 6, the spacer layer 5, the first solid electrolyte layer 4, the third substrate layer 3, the measurement electrode 44, and the reference electrode 42 constitute an electrochemical sensor cell, that is to say, a measurement-pump-control oxygen-partial-pressure detection sensor cell 82 to detect the oxygen partial pressure around the measurement electrode 44. A variable source 46 is controlled based on an electromotive force V2 detected in the measurement-pump-control oxygen-partial-pressure detection sensor cell 82.

The measurement gas introduced into the second inner space 40 reaches the measurement electrode 44 through the fourth diffusion limiting part 45 under a condition where the oxygen partial pressure is controlled. NOx in the measurement gas around the measurement electrode 44 is reduced (2NO → N₂+O₂), and oxygen is generated. The generated oxygen is pumped by the measurement pump cell 41. At this time, an electromotive force Vp2 of the variable source 46 is controlled so that an electromotive force V2 detected in the measurement-pump-control oxygen-partial-pressure detection sensor cell 82 is set to constant. Since the amount of oxygen generated around the measurement electrode 44 is proportional to the NOx concentration in the measurement gas, the NOx concentration in the measurement gas is calculated using the pump current Ip2 in the measurement pump cell 41. The pump current Ip2 is also referred to as the NOx current Ip2 hereinafter.

If the measurement electrode 44, the first solid electrolyte layer 4, the third substrate layer 3, and the reference electrode 42 are combined to constitute an oxygen-partial-pressure detection means as an electrochemical sensor cell, an electromotive force in accordance with a difference of an amount of oxygen generated by the reduction of the NOx component in the atmosphere around the measurement electrode 44 and an amount of oxygen contained in a reference atmosphere can be detected, and accordingly, a concentration of the NOx component in the measurement gas can be also obtained.

The second solid electrolyte layer 6, the spacer layer 5, the first solid electrolyte layer 4, the third substrate layer 3, the external pump electrode 23, and the reference electrode 42 constitute an electrochemical sensor cell 83, and the oxygen partial pressure in the measurement gas outside the sensor can be detected by an electromotive force Vref obtained by the sensor cell 83.

The sensor element 101 further includes a heater part 70 having a function of adjusting a temperature for heating sensor element 101 and keeping the temperature, in order to increase oxygen ion conductivity of the solid electrolyte constituting the base part.

The heater part 70 mainly includes a heater electrode 71, a heater element 72, a heater lead 72a, a through hole 73, and a heater insulating layer 74. The heater part 70 is embedded in the base part of the sensor element 101 except for the heater electrode 71.

The heater electrode 71 is an electrode formed to contact the lower surface of the first substrate layer 1 (the other main surface of the sensor element 101).

The heater element 72 is a resistance heating element provided between the second substrate layer 2 and the third substrate layer 3. The heater element 72 generates the heat by supplying power from the outside of the sensor element 101 via the heater electrode 71, the through hole 73, and the heater lead 72a which function as an energizing path. The heater element 72 is formed of Pt or mainly of Pt. The heater element 72 is embedded in a predetermined region in the sensor element 101 on a side including the gas introduction part so as to oppose the gas introduction part in a thickness direction of the element. The heater element 72 is provided to have a thickness of approximately 10 µm to 20 µm.

In the sensor element 101, the current is flowed into the heater element 72 via the heater electrode 71, thereby making the heater element 72 generate the heat, thus each part of the sensor element 101 can be heated to a predetermined temperature and kept to have the temperature. Specifically, the sensor element 101 is heated so that the temperature of the solid electrolyte and the electrode near the gas introduction part increases to approximately 700° C. to 900° C. The heating processing increases the oxygen ion conductivity of the solid electrolyte constituting the base part in the sensor element 101. The heating temperature at the time of heating by the heater element 72 in a case of using the gas sensor 100 (in a case of driving the sensor element 101) is referred to as a sensor element driving temperature.

The gas sensor 100 further includes a controller 110 controlling the operation of each part and specifying the NOx concentration based on the NOx current Ip2.

In the gas sensor 100 having such a configuration, oxygen contained in the measurement gas is pumped out through the operation of the main pump cell 21 and further of the auxiliary pump cell 50, and the measurement gas whose oxygen partial pressure is lowered enough not to substantially influence the measurement of NOx (for example, 0.0001 ppm to 1 ppm) reaches the measurement electrode 44. In the measurement electrode 44, NOx in the measurement gas which has reached the measurement electrode 44 is reduced, and oxygen is generated. The generated oxygen is pumped out by the measurement pump cell 41.The NOx current Ip2 flowing at the time of pumping out oxygen has a certain functional relationship (referred to as sensitivity characteristics hereinafter) with the concentration of NOx in the measurement gas.

The sensitivity characteristics are previously specified using a plural types of model gas whose NOx concentrations are already known in advance of the actually use of the gas sensor 100, and data thereof is stored in the controller 110. In the actual use of the gas sensor 100, signals indicating a value of the NOx current Ip2 flowing in accordance with the NOx concentration in the measurement gas is provided to the controller 110 from moment to moment, and the NOx concentration is continuously calculated based on the value and the specified sensitivity characteristics and output in the controller 110. According to the gas sensor 100, the NOx concentration in the measurement gas can be obtained almost in real time.

The value of the NOx current Ip2 may also depend on the oxygen concentration in the measurement gas. In such a case, the NOx concentration may be calculated after the NOx current Ip2 is corrected as necessary based on information (for example, the pump current Ip0 and the electromotive force V_{ref}) indicating the oxygen concentration in the measurement gas, thereby further increasing the accuracy.

### Provision of Durability of Inner Pump Electrode and Reduction of Offset Current

In the gas sensor 100, the NOx concentration is calculated by exploiting the fact that the pump current Ip2 is substantially proportional to the NOx concentration in the measurement gas under a condition that the oxygen partial pressure in the second inner space 40 is maintained constant. However, the pump current Ip2 is superimposed with offset current that flows when O₂ that is slightly present in the measurement gas is decomposed. The offset current corresponds to current that flows when the NOx concentration is zero (when no NOx is present in the measurement gas). Therefore, it can be said that the smaller the value of the offset current, the better the gas sensor 100 has measurement accuracy.

In the gas sensor 100 according to the present preferred embodiment, the sensor element 101 having the above-described configuration further satisfies a predetermined requirement, thereby achieving both provision of durability of the inner pump electrode 22 and reduction of the offset current. Specifically, the sensor element 101 is configured to further satisfy the following four requirements (a) to (d).
(a) the porosity P1 of the inner pump electrode 22: 10% to 25%;
(b) the porosity P2 of the auxiliary pump electrode 51: 30% to 50%;
(c) The ratio T1/T2 of a thickness T1 of the inner pump electrode 22 to a thickness T2 of the auxiliary pump electrode 51: 1.0 to 4.0;
(d) Reference current density: 0.05 mA/mm² to 0.5 mA/mm².

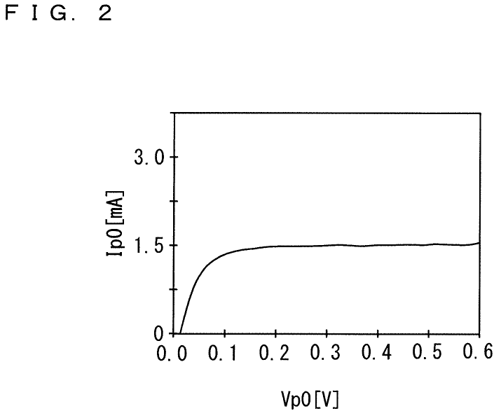

The reference current density is defined as the density (current value per unit area of the inner pump electrode 22) of current flowing to the main pump cell 21 of the sensor element 101 when the oxygen concentration of the measurement gas is 20.5%. For example, when FIG. 2 is a V-I curve showing the relation between the pump voltage Vp0 and the pump current Ip0 of the main pump cell 21 of the sensor element 101 where the oxygen concentration of the measurement gas is 20.5%, a value obtained by dividing the limiting current value of 1.5 mA in FIG. 2 by the electrode area of the inner pump electrode 22 is the reference current density of the sensor element 101.

The value of the reference current density at individual sensor element 101 is determined in accordance with the forms of the first diffusion limiting part 11 and the second diffusion limiting part 13, the magnitude of the diffusion resistance provided to the measurement gas by these sites, the shape of the first inner space 20, the shape (size) of the inner pump electrode 22, and the like. Thus, the reference current density is a value unique to the individual sensor element 101. In other words, the reference current density is a physical property (representative value) that characterizes the individual sensor element 101, and for example, the forms of the first diffusion limiting part 11 and the second diffusion limiting part 13 described above are different between the sensor elements 101 having reference current densities different from each other.

However, in the present preferred embodiment, the first inner space 20 only need to have a length (size in the element longitudinal direction) of 2 mm to 8 mm, a width (size in the element transverse direction) of 2 mm to 4 mm, and a thickness (size in the element thickness direction) of 50 µm to 400 µm, and the slits provided to the first diffusion limiting part 11 and the second diffusion limiting part 13 only need to have a total length of 0.5 mm to 1.5 mm, a width of 1 mm to 4 mm, and a thickness of 5 µm to 30 µm. In the case that single diffusion limiting part is provided between the gas inlet 10 and the first inner space 20 or that a diffusion limiting part of a porous layer is provided, these diffusion limiting parts only need to satisfy the above-described size.

Simple reduction of the offset current can be achieved by setting the porosity P1 of the inner pump electrode 22 and the porosity P2 of the auxiliary pump electrode 51 to be 10% to 50%, preferably 15% to 40%. However, in the case that the porosity P1 of the inner pump electrode 22 is larger than 30%, the inner pump electrode 22 is easily peeled off. Moreover, in the case that the porosity P2 of the auxiliary pump electrode 51 is larger than 50%, the auxiliary pump electrode 51 is easily peeled off.

Thus, in the present preferred embodiment, peeling of the inner pump electrode 22 and the auxiliary pump electrode is suppressed by limiting the ranges of the porosities P1 and P2 as with the requirements (a) and (b), and sufficient reduction of the offset current is achieved by further satisfying the other requirements (c) to (d). For example, the current value when the pump current Ip2 is measured for a model gas containing no NOx and having an oxygen concentration of 18% with the remainder being nitrogen is 0.2 µA or lower, preferably 0.1 µA or lower.

More specifically, in the case that the porosity P2 of the auxiliary pump electrode 51 is smaller than 30% and the ratio T1/T2 is smaller than 1.0, the oxygen concentration has gradient inside the auxiliary pump electrode 51 and the oxygen concentration in the second inner space 40 becomes high, and accordingly, the offset current increases, which is not preferable.

It is not preferable that the ratio T1/T2 is larger than 4.0 because it is not easy to form, with a high yield, the inner pump electrode 22 having a large film thickness, and the productivity is lowered.

In addition, it is not preferable that the reference current density is smaller than 0.05 mA/mm² because durability during long-term driving is lowered.

### Improvement of Feedback Controllability

In the gas sensor 100 according to the present preferred embodiment, the following requirements are satisfied in addition to the above-described four requirements so that the feedback controllability of each pump cell is improved. Specifically, the sensor element 101 is configured to further satisfy the following requirement (e).

(e) Porosity difference P2-P1: 30% or smaller.

When the requirement (e) is satisfied, the controllability of feedback control of the main pump cell 21, the auxiliary pump cell 50, and the measurement pump cell 41 for converging the electromotive force V0 at the main-pump-control oxygen-partial-pressure detection sensor cell 80, the electromotive force V1 at the auxiliary-pump-control oxygen-partial-pressure detection sensor cell 81, and the electromotive force V2 at the measurement pump control oxygen partial pressure detection sensor cell 82 to respective target values is increased. Specifically, a time until the electromotive forces V0, V1, and V2 each converge to a value within ±10% of the target value is shortened to 5.0 seconds or shorter, preferably 3.0 seconds or shorter.

As described above, according to the present preferred embodiment, the sensor element satisfies the following four requirements (a) to (d) so that provision of durability of the inner pump electrode and reduction of offset current are both achieved in the gas sensor.

In addition, the sensor element satisfies the requirement (e) so that improvement of feedback controllability of each pump cell is achieved.

### Manufacturing Process of Sensor Element

Described next is a process of manufacturing the sensor element 101 having the configuration and the feature described above. In the present preferred embodiment, the sensor element 101 is manufactured by forming a laminated body formed of green sheets containing an oxygen ion conductive solid electrolyte such as zirconia as a ceramic component, and then cutting and firing the laminated body.

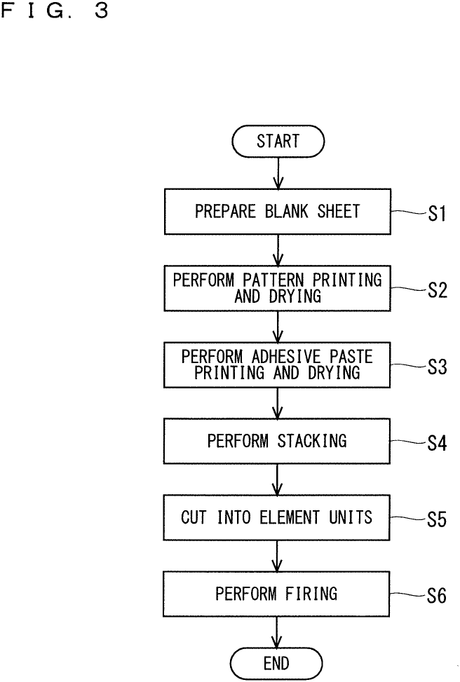

Described hereinafter as an example is a case of manufacturing the sensor element 101 including the six layers illustrated in FIG. 1. Prepared in such a case are six green sheets corresponding to the first substrate layer 1, the second substrate layer 2, the third substrate layer 3, the first solid electrolyte layer 4, the spacer layer 5, and the second solid electrolyte layer 6. FIG. 3 is a drawing showing a flow of processing in manufacturing a sensor element 101.

In manufacturing the sensor element 101, firstly, a blank sheet (not shown) which is a green sheet on which no pattern is formed is prepared (Step S1). As the sensor element 101 including the six layers is manufactured, six blank sheets are prepared to correspond to each layer.

The blank sheets have a plurality of sheet holes used for alignment in performing a printing and laminating the sheets. The sheet hole is previously formed in the blank sheet through, for example, punching processing using a punching device in a stage prior to the pattern formation. Green sheets corresponding to layers including the inner spaces also include penetrating portions corresponding to the inner spaces, which are also provided by the similar punching processing previously. The formation of the penetrating portion is performed in such a manner that the requirement (d) is satisfied in the sensor element 101 obtained in the end. A thickness of each blank sheet corresponding to each layer of the sensor element 101 needs not be the same as each other.

After the blank sheet corresponding to each layer is prepared, the pattern printing and dry processing are performed on each blank sheet (Step S2). Formed specifically are patterns of various types of electrodes, a pattern of the fourth diffusion limiting part 45, patterns of the heater element 72 and the heater insulating layer 74, and a pattern of an inner wiring not shown in the drawings. An application or a placement of a sublimation material for forming the first diffusion limiting part 11, the second diffusion limiting part 13, and the third diffusion limiting part 30 is also performed at a timing of the pattern printing. The application or placement is performed in such a manner that the requirement (d) is satisfied in the sensor element 101 obtained in the end.

The printing of each pattern is performed by applying a pattern formation paste prepared in accordance with characteristics required for each formation object on the blank sheet using a known screen printing technique. A known drying means can be used for drying processing after the printing.

In particular, the paste forming the inner pump electrode 22 and the auxiliary pump electrode 51 is prepared and applied so that the inner pump electrode 22 and the auxiliary pump electrode 51 obtained in the end satisfy at least the requirements (a) to (c).

After the pattern printing on each blank sheet is finished, processing of printing and drying an adhesive paste for laminating and attaching the green sheet corresponding to each layer on and to one another is performed (Step S3). A known screen printing technique can be used for printing the adhesive paste, and a known drying means can be used for drying processing after the printing.

Subsequently, the green sheets on which an adhesive agent has been applied are stacked in a predetermined order, and the stacked green sheets are crimped under a predetermined temperature condition and pressure condition to form one laminated body (Step S4). Specifically, the crimping is performed by stacking and holding the green sheets to be laminated on a predetermined laminating jig not shown while aligning the green sheets using the sheet holes, and then heating and pressurizing the green sheets together with the laminating jig using a laminating machine such as a known oil hydraulic pressing machine. The pressure, the temperature, and the time for heating and pressurizing depend on the laminating machine to be used, however, an appropriate condition may be determined to be able to achieve a favorable lamination.

When the laminated body is obtained as described above, subsequently, the laminated body is cut out at a plurality of locations to obtain an individual unit (referred to as the element body) of the sensor element 101 (Step S5).

The firing is performed on the element body at a firing temperature of approximately 1300° C. to 1500° C. (Step S6). The sensor element 101 is thereby manufactured. In other words, the sensor element 101 is manufactured through integrally firing the solid electrolyte layer and the electrode. The firing temperature is preferably set to 1200° C. to 1500° C. (for example, 1400° C.). The integrated firing is performed in the above manner, thus each electrode has sufficient adhesion strength in the sensor element 101.

The sensor element 101 obtained in such a manner is stored in a predetermined housing, and incorporated into a main body (not shown) of the gas sensor 100.

### Modifications

In the above-described preferred embodiment, the measurement electrode 44 is disposed in the second inner space 40 while being covered by the fourth diffusion limiting part 45 that functions as a porous protective film and provides a predetermined diffusion resistance to the measurement gas, and the amount of NOx flowing into the measurement electrode 44 is restricted by the fourth diffusion limiting part 45. However, instead, a third inner space communicated with the second inner space 40 may be provided by, for example, a slit or porous diffusion limiting part that provides, to the measurement gas, a diffusion resistance equivalent to that of the fourth diffusion limiting part 45, and the measurement electrode 44 may be provided in the third inner space. Provision of durability of the inner pump electrode 22 and reduction of the offset current are both achieved even for a sensor element including three inner spaces, as long as the four requirements (a) to (d) are satisfied. The feedback controllability of each pump cell is improved when the requirement (e) is further satisfied.

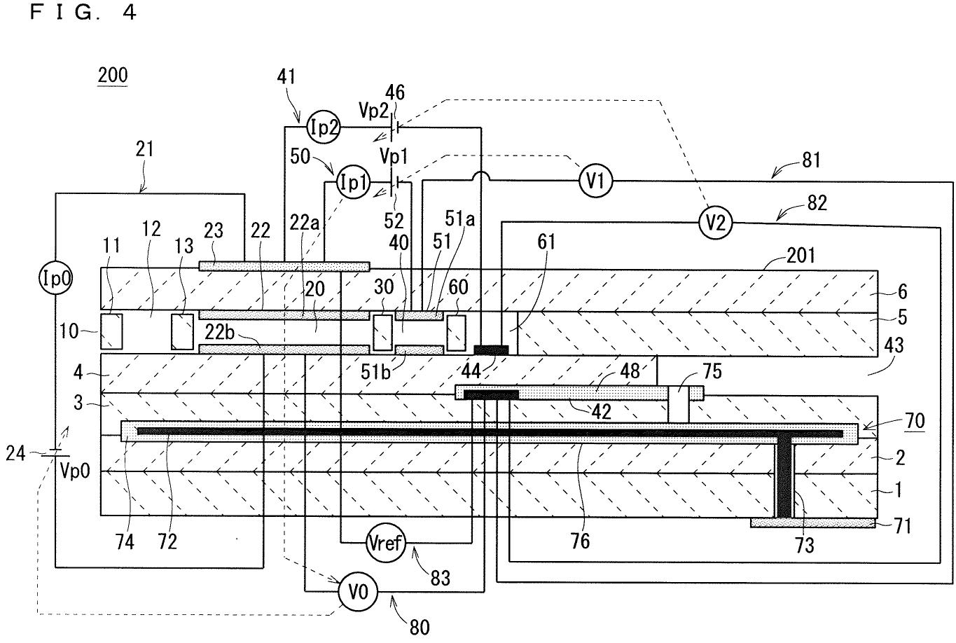

FIG. 4 is a diagram schematically showing an exemplary configuration of a gas sensor 200, including a vertical cross-sectional view of such a sensor element 201 in the longitudinal direction. The sensor element 201 includes a component providing common effects and functions with a component of the sensor element 101 shown in FIG. 1. Such a component is denoted by a reference sign identical to that of the corresponding component shown in FIG. 1, and detailed description thereof will be omitted unless necessary. The controller 110 is not shown.

The sensor element 201 is different from the sensor element 101 shown in FIG. 1 in that the first diffusion limiting part 11 also functions as the gas inlet 10, a third inner space 61 communicated with the second inner space 40 is provided by a fifth diffusion limiting part 60 having a slit shape similar to those of the first diffusion limiting part 11, the second diffusion limiting part 13, and the third diffusion limiting part 30, the measurement electrode 44 is provided on the upper surface of the first solid electrolyte layer 4 facing the third inner space 61, and the measurement electrode 44 is exposed to the third inner space 61. However, the sensor element 201 is same as the sensor element 101 in that a diffusion limiting part is interposed between the second inner space 40 and the measurement electrode 44.

Provision of durability of the inner pump electrode 22 and reduction of the offset current are both achieved when the sensor element 201 satisfies the four requirements (a) to (d). The feedback controllability of each pump cell is improved when the requirement (e) is further satisfied.

### Example

Nine kinds of gas sensors 100 (No.1 to No.9) having different combinations of the porosity P1 of the inner pump electrode 22, the porosity P2 of the auxiliary pump electrode 51, the thickness T1 of the inner pump electrode 22, the thickness T2 of the auxiliary pump electrode 51, and the reference current density were fabricated, and evaluation of the offset current, evaluation of durability of the sensor element 101, and evaluation of the feedback controllability were performed for each gas sensor 100. In the following, the drive temperature of the sensor element 101 where the gas sensor 100 was driven was set to 800° C.

The gas sensors 100 of No.1 to No.5 were fabricated to satisfy all requirements (a) to (e). The gas sensor 100 of No.6 was fabricated to satisfy all requirements (a) to (d) but not to satisfy the requirement (e). The V-I curve shown in FIG. 2 is for the gas sensor 100 of No.1. The gas sensors 100 of No.7 to No.9 were fabricated to satisfy the requirement (e) but not to satisfy at least one of the requirements (a) to (d).

Table 1 lists the porosity P1 of the inner pump electrode (main pump electrode) 22, the porosity P2 of the auxiliary pump electrode 51, the thickness T1 of the inner pump electrode 22, the thickness T2 of the auxiliary pump electrode 51, the reference current density, the porosity difference P2-P1, and the thickness ratio T1/T2 for each gas sensor 100. Table 1 also lists determination results in the evaluation of the offset current, the evaluation of the durability, and the evaluation of the feedback controllability.

Table 1

| No. | Porosity P1 [%] of main pump electrode | Porosity P2 [%] of auxiliary pump electrode | Thickness T1 [µm] of main pump electrode | Thickness T2 [µm] of auxiliary pump electrode | Reference current density [mA/mm²] | Porosity difference P2-P1 | T1/T2 | Determination 1 | Determination 2 | Determination 3 |
|---|---|---|---|---|---|---|---|---|---|---|
| 1 | 20 | 50 | 30 | 10 | 0.10 | 30 | 3.00 | ⊙ | ⊙ | ◯ |
| 2 | 15 | 40 | 15 | 15 | 0.12 | 25 | 1.00 | ⊙ | ⊙ | ⊙ |
| 3 | 10 | 40 | 20 | 15 | 0.05 | 30 | 1.33 | ⊙ | ⊙ | ◯ |
| 4 | 25 | 30 | 10 | 5 | 0.50 | 5 | 2.00 | ◯ | ◯ | ⊙ |
| 5 | 15 | 30 | 20 | 15 | 0.15 | 15 | 1.33 | ◯ | ⊙ | ⊙ |
| 6 | 10 | 50 | 15 | 15 | 0.20 | 40 | 1.00 | ⊙ | ⊙ | × |
| 7 | 30 | 30 | 10 | 15 | 0.60 | 0 | 0.67 | ◯ | × | ⊙ |
| 8 | 40 | 40 | 15 | 10 | 0.15 | 0 | 1.50 | ◯ | × | ⊙ |
| 9 | 15 | 25 | 15 | 20 | 0.20 | 10 | 0.75 | × | ⊙ | ⊙ |

The evaluation of the offset current was performed by introducing, into the sensor element 101 of each gas sensor 100, a measurement gas as a model gas containing no NOx and having an oxygen concentration of 18% with the remainder being nitrogen. Since the value of the pump current Ip2 obtained in this case corresponds to the offset current, it was determined that the offset current was reduced in the gas sensor 100 when the value was below a predetermined reference value. The determination in this aspect is referred to as Determination 1.

Specifically, for the gas sensor 100 in which the value of the pump current Ip2 was equal to or smaller than 0.1 µA, it was determined that the offset current was sufficiently reduced. In Table 1, a double circle is provided in the “Determination 1” cell of this gas sensor 100. For the gas sensor 100 in which the value of the pump current Ip2 is larger than 0.1 µA and equal to or smaller than 0.2 µA, it was determined that the offset current was sufficiently reduced to a practically allowable level. In Table 1, a circle is provided in the “Determination 1” cell of this gas sensor 100. For the gas sensor 100 in which the value of the pump current Ip2 is larger than 0.2 µA, which fell under neither of those, a cross is provided in the “Determination 1” cell in Table 1.

The evaluation of the durability of the sensor element 101 was performed subject to the change rate of the pump current Ip2 when the model gas containing NOx was used as the measurement gas before and after the gas sensor 100 was continuously driven for 3000 hours in the atmosphere.

Specifically, the model gas containing 500 ppm NOx, oxygen 18%, and the remainder nitrogen was introduced as the measurement gas into each of the unused above-described nine kinds of gas sensors 100, the pump current Ip2 (initial value) was obtained, and then the gas sensor 100 was continuously driven (held in the operating state) for 3000 hours in the atmosphere. Thereafter, the pump current Ip2 (final value) was obtained again by using the same model gas, the ratio of the difference value between the final value and the initial value relative to the initial value was calculated as the change rate of the pump current, and it was determined that the durability was provided when the value was equal to or smaller than a predetermined reference value. The determination in this aspect is referred to as Determination 2.

In this case, for the gas sensor 100 in which the change rate of the pump current was equal to or smaller than 15%, it was determined that the sensor element 101 had sufficient durability. In Table 1, a double circle is provided in the “Determination 2” cell of this gas sensor 100. For the gas sensor 100 in which the change rate of the pump current was larger than 15% and equal to or smaller than 20%, it was determined that the sensor element 101 had durability at a practically allowable level. In Table 1, a circle is provided in the “Determination 2” cell of this gas sensor 100. For the gas sensor 100 in which the change rate of the pump current was larger than 20%, which fell under neither of those, a cross is provided in the “Determination 2” cell in Table 1.

The evaluation of the feedback controllability was performed subject to temporal change of the electromotive force V1 at the auxiliary-pump-control oxygen-partial-pressure detection sensor cell 81 and temporal change of the electromotive force V2 at the measurement-pump-control oxygen-partial-pressure detection sensor cell 82, with attaching the gas sensor 100 to the exhaust gas pipe piping of an automobile and driving the gas sensor 100 while the gasoline engine of the automobile was operating under predetermined operating conditions (the engine speed was 4000 rpm, the exhaust gas gauge pressure was 20 kPa, and the λ value was 0.83). When the time required for each electromotive force to converge from the actually measured value to a predetermined value was equal to or shorter than a predetermined value, it was determined that the feedback controllability was sufficient. The determination in this aspect is referred to as Determination 3.

Specifically, the target value of the electromotive force V1 was set to be 380 mV and the target value of the electromotive force V2 was set to be 400 mV, and when the time (hereinafter referred to as a 10% convergence time) required for the actually measured value of each electromotive force to converge within ±10% of the target value was equal to or shorter than 3.0 seconds, it was determined that the gas sensor 100 had favorable feedback controllability. In Table 1, a double circle is provided in the “Determination 3” cell of the corresponding gas sensor 100. When the 10% convergence time of each electromotive force was equal to or shorter than 5.0 seconds, it was determined that the gas sensor 100 had feedback controllability at a practically allowable level. In Table 1, a circle is provided in the “Determination 3” cell of the corresponding gas sensor 100. For the gas sensor 100 in which the 10% convergence time of at least one electromotive force was longer than 5.0 seconds, which fell under neither of those, a cross is provided in the “Determination 3” cell in Table 1.

In Table 1, a double circle or a circle is provided in Determination 1 to Determination 3 for each of the gas sensors 100 of No.1 to No.5 satisfying all requirements (a) to (e). In particular, a double circle is provided in Determination 1 to Determination 3 for the gas sensor 100 of No.2.

For the gas sensor 100 of No.6 satisfying the requirements (a) to (d) but not satisfying the requirement (e), a double circle is provided in Determination 1 and Determination 2, but a cross is provided in Determination 3.

For the gas sensors 100 of No.7 to No.9 satisfying the requirements (e) but not satisfying at least one of the requirements (a) to (d), a double circle is provided in Determination 3, but a cross is provided in Determination 1 or Determination 2.

These results indicate that the gas sensor 100 in which the durability of the inner pump electrode 22 is provided and the offset current is reduced can be obtained by satisfying the requirements (a) to (d).

When the sensor elements 101 after the evaluation of the durability was performed were checked, peeling at the inner pump electrode 22 was found only for the sensor elements 101 of No.7 and No.8 provided with a cross in Determination 2. This result is thought to indicate that the peeling of the inner pump electrode 22 is a factor of the durability degradation.

In addition, it can be thought that a gas sensor provided with the feedback controllability can be obtained by satisfying the requirement (e).

While the invention has been shown and described in detail, the foregoing description is in all aspects illustrative and not restrictive. It is therefore understood that numerous modifications and variations can be devised without departing from the scope of the invention.

What is claimed is:

1. A method of fabricating a limiting current type gas sensor, the limiting current type gas sensor comprising a sensor element made of an oxygen-ion conductive solid electrolyte and capable of specifying a concentration of NOx in a measurement gas, said sensor element comprising:
a gas inlet through which the measurement gas is introduced from an external space;
a first inner space communicated with said gas inlet under a predetermined diffusion resistance;
a second inner space communicated with said first inner space under a predetermined diffusion resistance;
a main pump cell as an electrochemical pump cell including an inner pump electrode provided facing said first inner space, an external pump electrode provided on a surface of said sensor element, and said solid electrolyte provided between said inner pump electrode and said external pump electrode;
an auxiliary pump cell as an electrochemical pump cell including an auxiliary pump electrode provided facing said second inner space, said external pump electrode, and said solid electrolyte provided between said auxiliary pump electrode and said external pump electrode;
a measurement electrode disposed inside said sensor element and interposing at least a diffusion limiting part between said measurement electrode and said second inner space; and
a measurement pump cell as an electrochemical pump cell including said measurement electrode, said external pump electrode, and said solid electrolyte provided between said measurement electrode and said external pump electrode,
wherein the method comprises the steps of:
forming said inner pump electrode to have a porosity P1 of 10% to 25%:
forming said auxiliary pump electrode to have a porosity P2 of 30% to 50%;
forming the inner pump electrode to have thickness TI and the auxiliary pump electrode to have a thickness T2 such that a ratio T1/T2 is 1.0 to 4.0; and
forming said main pump cell to have a reference current density of 0.05 mA/mm² to 0.5 mA/mm², said reference current density being a current density when said measurement gas has an oxygen concentration of 20.5%.

2. The method of fabricating a limiting current type gas sensor according to claim 1, further comprising the steps of:
forming said inner pump electrode and said auxiliary pump electrode such that a porosity difference P2-P1 between said inner pump electrode and said auxiliary pump electrode is 30% or smaller.

3. The method of fabricating a limiting current type gas sensor according to claim 1, further comprising the step of:
forming said inner pump electrode and said auxiliary pump electrode to each have a thickness of 5 µm to 30 µm and an area of 5 mm² to 20 mm².

4. The method of fabricating a limiting current type gas sensor according to claim 2, further comprising the step of:
forming said inner pump electrode and said auxiliary pump electrode to each have a thickness of 5 µm to 30 µm and an area of 5 mm² to 20 mm².
